(19) United States
(12) Patent Application Publication
(10) Pub. No.: US 2012/0294040 A1
(43) Pub. Date: Nov. 22, 2012

(54) LIGHT-EMITTING DIODE HEAT-DISSIPATION STRUCTURE AND BACKLIGHT MODULE

(75) Inventors: Yanxue Zhang, Shenzhen (CN); Yicheng Kuo, Shenzhen (CN)

(73) Assignee: Shenzhen China Star Optoelectronics Technology Co. Ltd., Shenzhen (CN)

(21) Appl. No.: 13/203,278

(22) PCT Filed: May 23, 2011
(86) PCT No.: PCT/CN11/74485

§ 371 Date: Aug. 25, 2011

(30) Foreign Application Priority Data
May 16, 2011 (CN) 201120155837.5

(51) Int. Cl. G09F 13/04; F21V 29/00

(52) U.S. Cl. 362/612; 362/249.02

(57) ABSTRACT

The present invention provides a light-emitting diode (LED) heat-dissipation structure and a backlight module. A plurality of heat-dissipation lamp holders and at least one circuit board are disposed on an upper surface of a heat-dissipation bottom plate of the LED heat-dissipation structure. A recess is formed on a top surface of each of the heat-dissipation lamp holders, and at least one LED chip is disposed in each recess. Two lead wires are electrically connected between the LED chip and the circuit board. The heat of the LED chips is dissipated outside by the heat-dissipation lamp holders and the heat-dissipation bottom plate with being obstructed by the circuit board, thus improving the heat-dissipation efficiency and life time of the LED heat-dissipation structure.

### FIELD OF THE INVENTION

The present invention relates to a light-emitting diode (LED) heat-dissipation structure and a backlight module, and more particularly to an LED heat dissipation structure and a backlight module capable of raising heat dissipation efficiency thereof.

### BACKGROUND OF THE INVENTION

A liquid crystal display (LCD) is a kind of flat panel display (FPD), which shows images by the property of liquid crystal material. Compared with other display devices, the liquid crystal display has the advantages in lightweight, compactness, low driving voltage and low power consumption, and thus has already become the mainstream produce in the whole consumer market. However, the liquid crystal material of the liquid crystal display cannot emit light by itself, and must depend upon an external light source. Thus, the liquid crystal display further has a backlight module to provide the needed light source.

Generally, the backlight module can be divided into two types: a side backlight module and a bottom backlight module. Traditionally, the backlight module uses a cold cathode fluorescent lamp (CCFL), a hot cathode fluorescent lamp (HCFL) or a semiconductor light emitting element as the light source, wherein the semiconductor light emitting element mainly uses a light emitting diode (LED) to emit light. The light-emitting-diode is better than the cold cathode fluorescent lamp in energy saving, longer lifetime, lightweight and compact volume, so that there is a trend to gradually replace the cold cathode fluorescent lamp and thus the LED will be the mainly light source of the backlight module for the liquid crystal display in the future.

Currently, the LED is almost a chip which is disposed on a heat sink for semiconductor packaging. Subsequently, the LED chip is mounted on an elongated circuit board and an elongated aluminum bar, so as to form a light bar (LB). Finally, the rear face of the light bar is attached to an aluminum heat dissipation plate, thereby forming an LED heat dissipation structure. However, there are some drawbacks in the above-mentioned LED heat dissipation structure. In a working process, the temperature of the LED chip of the LED heat dissipation structure is very high, and the heat of the LED heat dissipation structure is indirectly transmitted to the aluminum heat dissipation plate through the heat sink, the circuit board and the aluminum bar. Since a print circuit board (PCB) disposed between the LED heat dissipation structure and the aluminum bar is made of a material with a high thermal resistance, it can not help the LED heat dissipation structure to immediately transmit the heat to the aluminum bar and the aluminum heat dissipation plate, resulting in a higher temperature around the LED heat dissipation structure and an uneven temperature of each display area of the LCD. This causes a arising a reddish phenomenon, thus affecting the image quality of the LCD.

Moreover, the raised temperature of the light-emitting-diode during working may easily affect the emitting efficiency and the working stability thereof, so that the lifetime thereof also may be lowered due to a long-term high temperature status. Also, if the LED package structure are simply attached to the fixed plate only by an adhesive or fastened on the fixed plate by screws, the LED package structure and the fixed plate can not be directly in thermal contact with each other (or an insulation adhesive is sandwiched therebetween, or the interfaces therebetween are not in tight contact with each other), so that the heat-dissipation efficiency thereof will be affected in a certain degree. Besides, the whole thickness thereof will be increased, and it is unfavorable for the design of lighting and thinning.

As described above, the conventional LED use the heat sink for heat dissipation, but the heat of LED, which is welded to the PCB, can not be dissipated efficiently by the heat sink due to a low coefficient of thermal conductivity of the PCB. Besides, the conventional heat-dissipation structure needs additional heat-dissipation structures, such as the aluminum bar, thus raising the cost and complexity for assembly.

As a result, it is necessary to provide an LED heat-dissipation structure and a backlight module to solve the LED heat-dissipation problems existing in the conventional technology.

### SUMMARY OF THE INVENTION

The present invention provides an LED heat-dissipation structure and a backlight module to solve the LED heat-dissipation problems existing in the conventional technology.

A primary object of the present invention is to provide an LED heat-dissipation structure and a backlight module. The LED heat-dissipation structure comprises heat-dissipation bottom plate, a plurality of heat-dissipation lamp holders, a plurality of LED chips and at least one circuit board. The heat-dissipation bottom plate is bar-shaped. The plurality of heat-dissipation lamp holders are pillared and arranged as a row on an upper surface of the heat-dissipation bottom plate. A recess is formed on a top surface of each of the heat-dissipation lamp holders. The plurality of LED chips disposed in the recesses of the heat-dissipation lamp holders are electrically connected to the circuit board by lead wires. The circuit board is disposed on the upper surface of the heat-dissipation bottom plate.

To achieve the above-mentioned purposes, the present invention provides an LED heat-dissipation structure comprising:

a heat-dissipation bottom plate being bar-shaped and having a upper surface;

a plurality of heat-dissipation lamp holders being pillared and arranged as a row on the, upper surface of the heat-dissipation bottom plate, wherein a recess is formed on a top surface of each of the heat-dissipation lamp holders;

a plurality of LED chips disposed in the recesses of the heat-dissipation lamp holders, respectively; and

a circuit board disposed on the upper surface of the heat-dissipation bottom plate.

In one embodiment of the present invention, each of the LED chips is electrically connected to the circuit board by two lead wires.

In one embodiment of the present invention, the bottoms of the heat-dissipation lamp holders have grooves, and a portion of the circuit board is fitted into the grooves.

In one embodiment of the present invention, the heat-dissipation bottom plate and the heat-dissipation lamp holders are formed as one-piece.

To achieve the above-mentioned purposes, the present invention provides an LED heat-dissipation structure comprising:

a heat-dissipation bottom plate being bar-shaped and having a upper surface;

a plurality of heat-dissipation lamp holders being pillared and arranged as a row on the upper surface of the heat-dissipation bottom plate, wherein a recess is formed on a top surface of each of the heat-dissipation lamp holders;

a plurality of LED chips disposed in the recesses of the heat-dissipation lamp holders, respectively; and

two circuit boards disposed on the upper surface of the heat-dissipation bottom plate and at two sides of the heat-dissipation lamp holders, respectively.

In one embodiment of the present invention, each of the LED chips is electrically connected to the two circuit boards by the two lead wires.

In one embodiment of the present invention, the bottoms of the heat-dissipation lamp holders have grooves, and a portion of the circuit board is fitted into the grooves.

In one embodiment of the present invention, the heat-dissipation bottom plate and the heat-dissipation lamp holders are formed as one-piece.

To achieve the above-mentioned purposes, the present invention provides a backlight module comprising a back bezel, a light guide plate, an optical film assembly and a plastic frame, wherein the back bezel has a side-wall portion positioned at one or more sides thereof, and the light guide plate is carried on the back bezel, and the optical film assembly is disposed on the light guide plate, and the periphery of the back bezel is covered by the plastic frame, and at least one LED heat-dissipation structure is disposed on the inner side of the side-wall portion of at least one side of the back bezel, and the LED heat-dissipation structure comprises:

a heat-dissipation bottom plate being bar-shaped and having a upper surface;

a plurality of heat-dissipation lamp holders being pillared and arranged as a row on the upper surface of the heat-dissipation bottom plate, wherein a recess is formed on a top surface of each of the heat-dissipation lamp holders;

a plurality of LED chips disposed in the recesses of the heat-dissipation lamp holders, respectively; and

at least one circuit board disposed on the upper surface of the heat-dissipation bottom plate.

In one embodiment of the present invention, at least one circuit board is a circuit board, and each of the LED chips is electrically connected to the circuit board by two lead wires.

In one embodiment of the present invention, at least one circuit board is two circuit boards, and each of the LED chips is electrically connected to the two circuit boards by two lead wires.

In one embodiment of the present invention, the bottoms of the heat-dissipation lamp holders have grooves, and a portion of the circuit board is fitted into the grooves.

In one embodiment of the present invention, the heat-dissipation bottom plate and the heat-dissipation lamp holders are formed as one-piece.

The LED heat-dissipation structure and the backlight module of the present invention can dissipate the heat generated by the LED chips outside through the heat-dissipation lamp holders and the heat-dissipation bottom plate without being blocked by the circuit board, thus improving the heat-dissipation efficiency and life time of the LED heat-dissipation structure. Furthermore, an additional heat-dissipation structure, such as an Al heat sink, is not necessary for the LED heat-dissipation structure, thereby simplifying the design of the LED heat-dissipation structure and saving the assembly cost thereof.

The structure and the technical means adopted by the present invention to achieve the above-mentioned and other objects can be best understood by referring to the following detailed description of the preferred embodiments and the accompanying drawings:

### DESCRIPTION OF THE DRAWINGS

FIG. 1 is a partially perspective view of an LED heat-dissipation structure according to a first embodiment of the present invention;

FIG. 2 is a partially cross-sectional view of the LED heat-dissipation structure according to the first embodiment of the present invention;

FIG. 3 is a partially cross-sectional view of the LED heat-dissipation structure disposed on a backlight module according to the first embodiment of the present invention; and

FIG. 4 is a perspective and cross-sectional view of an LED heat-dissipation structure according to a second embodiment of the present invention.

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

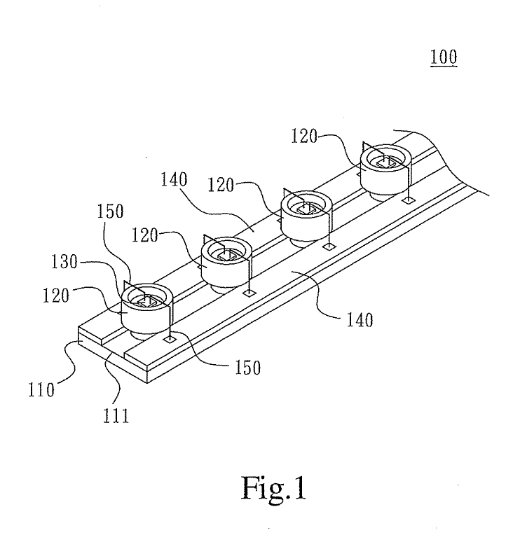

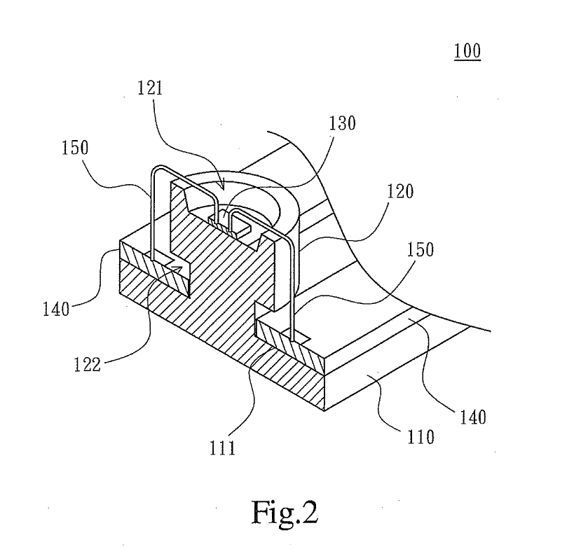

Referring now to FIG. 1 and FIG. 2, FIG. 1 is a partially perspective view of an LED heat-dissipation structure according to a first embodiment of the present invention, and FIG. 2 is a partially cross-sectional view of the LED heat-dissipation structure according to the first embodiment of the present invention. The LED heat-dissipation structure 100 of the first embodiment of the present invention is mainly applied to the field of lighting or liquid crystal display (LCD), and more particularly to a backlight module of the LCD. The foregoing components of the present invention will be described more detailed hereinafter.

The LED heat-dissipation structure 100 of the present invention mainly comprises a heat-dissipation bottom plate 110, a plurality of heat-dissipation lamp holders 120, a plurality of LED chips 130 and two circuit boards 140. The heat-dissipation bottom plate 110 is bar-shaped and has an upper surface 111. The plurality of LED chips 130 are pillared and arranged as a row on the upper surface 111 of the heat-dissipation bottom plate 110, wherein a recess 121 is formed on a top surface of each of the heat-dissipation lamp holders 120, and at least one of the LED chips 130 is correspondingly disposed in the recess 121 of each of the heat-dissipation lamp holders 120. The circuit boards 140 are disposed on the upper surface 111 of the heat-dissipation bottom plate 110 and at two sides of the heat-dissipation lamp holders 120, respectively.

Referring to FIG. 1 again, each of the LED chips 130 is electrically connected to the circuit boards 140 by two lead wires 150. More specifically, one end of the lead wire 150 is connected to a contact or an extending electrode (not shown) of the LED chip 130, and another end of the lead wire 150 is connected to a welding pad (not shown) of the circuit board 140. Furthermore, the LED chips 130 are lighted by a circuit on the circuit boards 140 in a series connection or a parallel connection.

Besides, preferably, the bottoms of the heat-dissipation lamp holders 120 have grooves 122. The grooves 122 may be annular grooves as shown in. FIG. 2 or straight grooves. A portion of the circuit boards 140 can be fitted into the grooves 122 for utilizing space efficiently.

Moreover, preferably, the heat-dissipation bottom plate 110 and the heat-dissipation lamp holders 120 are formed as one-piece for improving the thermal conductivity thereof and simplifying manufacture thereof. The heat-dissipation bottom plate 110 and the heat-dissipation lamp holders 120 are made of a material which is easy for heat-dissipation and processing, such as aluminum.

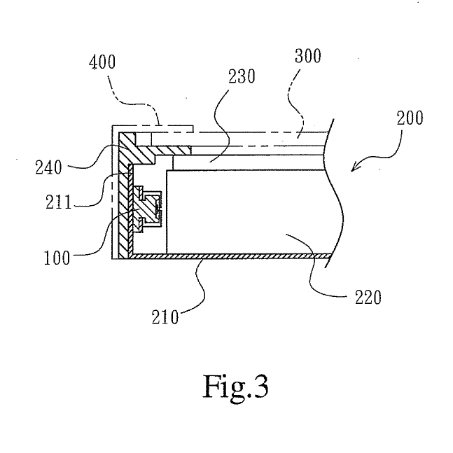

Referring now to FIG. 3, FIG. 3 is a partially cross-sectional view of the LED heat-dissipation structure disposed on a backlight module according to the first embodiment of the present invention. The backlight module 200 comprises a back bezel 210, a light guide plate 220, an optical film assembly 230 and a plastic frame 240. The back bezel 210 has a vertical side-wall portion 211 positioned at one or more sides thereof. The light guide plate 220 is carried on the back bezel 210. The optical film assembly 230 is disposed on the light guide plate 220. The periphery of the back bezel 210 is covered by the plastic frame 240. The optical film assembly 230 and the light guide plate 220 are held by the plastic frame 240 from above to below, so as to form the side-light type backlight module 200.

Furthermore, a liquid crystal display panel 300 is disposed on the backlight module 200, and the liquid crystal display panel 300 and the backlight module 200 are covered and held by a casing 400, so as to be assembled as an LCD apparatus.

In this case, the at least one LED heat-dissipation structure 100 is disposed on the inner side of the side-wall portion 211 of at least one side of the back bezel 210. The LED heat-dissipation structure 100 can be attached to the side-wall portion 211 of the back bezel 210 by screwing, engaging or bonding.

Referring to FIG. 2 and FIG. 3 again, the heat of the LED chips 130 can be dissipated outside by the heat-dissipation lamp holders 120 and the heat-dissipation bottom plate 110 without being obstructed by the circuit boards 140. Therefore, the heat transmitted to the heat-dissipation bottom plate 110 can be further transmitted to the back bezel 210 by the side-wall portion 211 thereof, and be dissipated by the outer surface of the back bezel 210. Since the heat of the LED chips 130 can be dissipated efficiently, the heat-dissipation efficiency and life time of the LED heat-dissipation structure 100 are improved. Moreover, an additional heat-dissipation structure, such as an Al heat sink, is not necessary for the LED heat-dissipation structure 100, thereby simplifying the design of the LED heat-dissipation structure 100 and saving the assembly cost thereof.

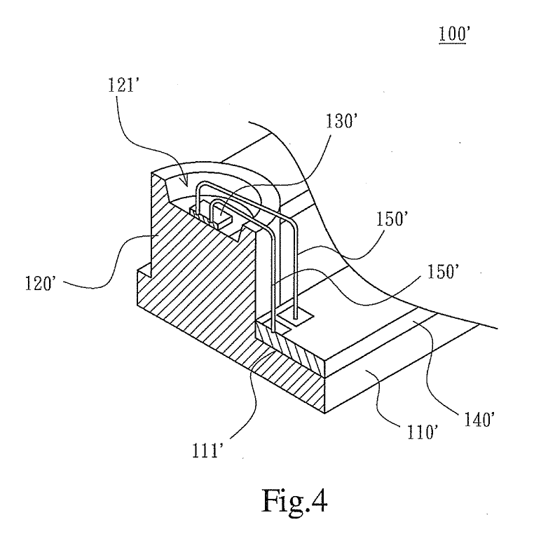

Referring now to FIG. 4, a perspective and cross-sectional view of an LED heat-dissipation structure according to a second embodiment of the present invention is illustrated. The LED heat-dissipation structure 100′ of this embodiment of the present invention is similar to the LED heat-dissipation structure 100 of the first embodiment, so as to use similar terms and numerals of the first embodiment. The LED heat-dissipation structure 100′ mainly comprises a heat-dissipation bottom plate 110′, a plurality of heat-dissipation lamp holders 120′, a plurality of LED chips 130′ and a circuit board 140′. The difference between the LED heat-dissipation structure 100′ of the second embodiment of the present invention and the LED heat-dissipation structure 100 of the first embodiment is that the heat-dissipation lamp holders 120′ of the LED heat-dissipation structure 100′ of this embodiment is disposed at one side of the upper surface 111′ of the heat-dissipation bottom plate 110, and the only one circuit board 140′ is disposed on the upper surface 111′ of the heat-dissipation bottom plate 110′. In this embodiment, each of the LED chips 130′ is electrically connected to the circuit boards 140′ by two lead wires 150′, and is lighted by a circuit of the circuit boards 140′.

Moreover, the grooves 122 of the first embodiment are omitted in the heat-dissipation lamp holders 120′ of this embodiment, thereby making it easier to fabricate and assemble the LED heat-dissipation structure 100′.

As mentioned above, the conventional LED heat-dissipation structure uses a heat sink for heat-dissipation, but the heat in the heat sink is obstructed by the circuit board and can not be dissipated efficiently. In comparison with the conventional LED heat-dissipation structure, the LED heat-dissipation structure 100 of the present invention comprises a heat-dissipation bottom plate 110, a plurality of heat-dissipation lamp holders 120, a plurality of LED chips 130 and at least one. circuit board 140. By directly connecting the heat-dissipation lamp holders 120 and the heat-dissipation bottom plate 110, heat generated by the LED chips 130 can be dissipated outside through the heat-dissipation lamp holders 120 and the heat-dissipation bottom plate 110, and will not be blocked by the circuit board 140. Moreover, the heat transmitted to the heat-dissipation bottom plate 110 can be further transmitted to the back bezel 210 by the side-wall portion 211 thereof, and be dissipated by the air outside the back bezel 210. Therefore, the heat of the LED chips 130 can be dissipated efficiently, and the heat-dissipation efficiency and life time of the LED heat-dissipation structure 100 are improved.

The present invention has been described with a preferred embodiment thereof and it is understood that many changes and modifications to the described embodiment can be carried out without departing from the scope and the spirit of the invention that is intended to be limited only by the appended claims.

1. A light-emitting diode (LED) heat-dissipation structure, characterized in that: the LED heat-dissipation structure comprising:
a heat-dissipation bottom plate being bar-shaped and having a upper surface;
a plurality of heat-dissipation lamp holders being pillared and arranged as a row on the upper surface of the heat-dissipation bottom plate, wherein a recess is formed on a top surface of each of the heat-dissipation lamp holders;
a plurality of LED chips disposed in the recesses of the heat-dissipation lamp holders, respectively; and
a circuit board disposed on the upper surface of the heat-dissipation bottom plate.

2. The LED heat-dissipation structure according to claim 1, characterized in that: each of the LED chips is electrically connected to the circuit board by two lead wires.

3. The LED heat-dissipation structure according to claim 1, characterized in that: the bottoms of the heat-dissipation lamp holders have grooves, and a portion of the circuit board is fitted into the grooves.

4. The LED heat-dissipation structure according to claim 1, characterized in that: the heat-dissipation bottom plate and the heat-dissipation lamp holders are formed as one-piece.

5. An LED heat-dissipation structure, characterized in that: the LED heat-dissipation structure comprising:
a heat-dissipation bottom plate being bar-shaped and having a upper surface;
a plurality of heat-dissipation lamp holders being pillared and arranged as a row on the upper surface of the heat-dissipation bottom plate, wherein a recess is formed on a top surface of each of the heat-dissipation lamp holders;
a plurality of LED chips disposed in the recesses of the heat-dissipation lamp holders, respectively; and
two circuit boards disposed on the upper surface of the heat-dissipation bottom plate and at two sides of the heat-dissipation lamp holders, respectively.

6. The LED heat-dissipation structure according to claim 5, characterized in that: each of the LED chips is electrically connected to the two circuit boards by two lead wires.

7. The LED heat-dissipation structure according to claim 5, characterized in that: the bottoms of the heat-dissipation lamp holders have grooves, and a portion of the circuit board is fitted into the grooves.

8. The LED heat-dissipation structure according to claim 5, characterized in that: the heat-dissipation bottom plate and the heat-dissipation lamp holders are formed as one-piece.

9. A backlight module comprising a back bezel, a light guide plate, an optical film assembly and a plastic frame, wherein the back bezel has a side-wall portion positioned at one or more sides thereof, and the light guide plate is carried on the back bezel, and the optical film assembly is disposed on the light guide plate, and the periphery of the back bezel is covered by the plastic frame, characterized in that: at least one LED heat-dissipation structure is disposed on the inner side of the side-wall portion of at least one side of the back bezel, and the LED heat-dissipation structure comprises:
a heat-dissipation bottom plate being bar-shaped and having a upper surface;
a plurality of heat-dissipation lamp holders being pillared and arranged as a row on the upper surface of the heat-dissipation bottom plate, wherein a recess is formed on a top surface of each of the heat-dissipation lamp holders;
a plurality of LED chips disposed in the recesses of the heat-dissipation lamp holders, respectively; and
at least one circuit board disposed on the upper surface of the heat-dissipation bottom plate.

10. The backlight module according to claim 9, characterized in that: at least one circuit board is a circuit board, and each of the LED chips is electrically connected to the circuit board by two lead wires.

11. The backlight module according to claim 9, characterized in that: at least one circuit board is two circuit boards, and each of the LED chips is electrically connected to the two circuit boards by two lead wires.

12. The backlight module according to claim 9, characterized in that: the bottoms of the heat-dissipation lamp holders have grooves, and a portion of the circuit board is fitted into the grooves.

13. The backlight module according to claim 9, characterized in that: the heat-dissipation bottom plate and the heat-dissipation lamp holders are formed as one-piece.
